(19) United States
(12) Patent Application Publication
(10) Pub. No.: US 2026/0080607 A1
(43) Pub. Date: Mar. 19, 2026

(54) REMOTE SENSOR ASSISTED EXTENDED REALITY

(71) Applicant: QUALCOMM Incorporated, San Diego, CA (US)

(72) Inventors: Upal MAHBUB, El Cajon, CA (US); Pirazh KHORRAMSHAHI, San Diego, CA (US); Gokce DANE, San Diego, CA (US); Adithya Reddy NALLABOLU, San Diego, CA (US)

(21) Appl. No.: 18/887,018

(22) Filed: Sep. 16, 2024

(51) Int. Cl. G06T 15/20; G06T 3/00; G06T 7/73; G06T 17/20

(52) U.S. Cl. CPC G06T 15/20; G06T 3/00; G06T 7/73; G06T 17/20; G06T 2207/20081; G06T 2207/20084; G06T 2207/30244

(57) ABSTRACT

Techniques and systems are provided for rendering images for display by an extended reality device. For instance, a process can include receiving, from a remote sensor, information associated with a target area of a real environment in which an extended reality apparatus is located; generating a virtual representation of the target area using the received information; rendering the virtual representation of the target area from a point of view of the extended reality apparatus; and outputting the rendered virtual representation of the target area from the point of view of the extended reality apparatus for display.

### FIELD

This application is related to generating content for extended reality (XR) systems. For example, aspects of the application relate to systems and techniques for remote sensor assisted XR (e.g., using sensor data at an XR device received from one or more remote sensors, such as a camera and/or other sensor from a drone or other system or device).

### BACKGROUND

Extended reality (XR) technologies can be used to present virtual content to users, and/or can combine real environments from the physical world and virtual environments to provide users with XR experiences. The term XR can encompass virtual reality (VR), augmented reality (AR), mixed reality (MR), and the like. XR devices or systems can allow users to experience XR environments by overlaying virtual content onto images of a real-world environment, which can be viewed by a user through an XR device (e.g., a head-mounted display (HMD), extended reality glasses, or another device). For example, an XR device can display a virtual environment to a user. The virtual environment is at least partially different from the real-world environment in which the user is in. The user can generally change their view of the virtual environment interactively, for example by tilting or moving the XR device (e.g., the HMD or other device).

An XR device or system can include a “see-through” display that allows the user to see their real-world environment based on light from the real-world environment passing through the display. In some cases, an XR device can include a “pass-through” display that allows the user to see their real-world environment, or a virtual environment based on the real-world environment, using a view of the environment being captured by one or more cameras and displayed on the display. “See-through” or “pass-through” XR devices can be worn by users while the users are engaged in activities in the real-world environment.

In some cases, XR devices may have a limited line of sight. For example, an XR device may include an HMD including cameras that may be used to capture images of the environment that may be displayed, at least in part, on the HMD display. In some cases, these cameras may be partially or wholly blocked by obstacles in the foreground. For example, an XR user may be interesting in observing a region that is further away which is blocked by a closer obstacle. As a more specific example, a spectator at an event may have their view blocked by other spectator, or a biker/skier/hiker may have their view of a particular area blocked by trees, a hill, dust cloud, etc. In some cases, techniques for extending/expanding the field of view of an XR device using remote sensors may be useful.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

In one illustrative example, an extended reality apparatus is provided. The apparatus includes a memory and at least one processor coupled to the memory. The at least one processor is configured to: receive, from a remote sensor, information associated with a target area of a real environment in which the extended reality apparatus is located; generate a virtual representation of the target area using the received information; render the virtual representation of the target area from a point of view of the extended reality apparatus; and output the rendered virtual representation of the target area from the point of view of the extended reality apparatus for display.

As another example, a method for generating a view is provided. The method includes: receiving, from a remote sensor, information associated with a target area of a real environment in which an extended reality apparatus is located; generating a virtual representation of the target area using the received information; rendering the virtual representation of the target area from a point of view of the extended reality apparatus; and outputting the rendered virtual representation of the target area from the point of view of the extended reality apparatus for display.

In another example, a non-transitory computer-readable medium having stored thereon instructions is provided. The instructions, when executed by at least one processor, cause the at least one processor to: receive, from a remote sensor, information associated with a target area of a real environment in which the extended reality apparatus is located; generate a virtual representation of the target area using the received information; render the virtual representation of the target area from a point of view of the extended reality apparatus; and output the rendered virtual representation of the target area from the point of view of the extended reality apparatus for display.

As another example, an apparatus for generating a view is provided. The apparatus includes: means for receiving, from a remote sensor, information associated with a target area of a real environment in which an extended reality apparatus is located; means for generating a virtual representation of the target area using the received information; means for rendering the virtual representation of the target area from a point of view of the extended reality apparatus; and means for outputting the rendered virtual representation of the target area from the point of view of the extended reality apparatus for display.

In some aspects, the apparatus can include or be part of an extended reality device (e.g., a virtual reality (VR) device, an augmented reality (AR) device, or a mixed reality (MR) device), a mobile device (e.g., a mobile telephone or other mobile device), a wearable device (e.g., a network-connected watch or other wearable device), a personal computer, a laptop computer, a server computer, a television, a video game console, or other device. In some aspects, the apparatus further includes at least one camera for capturing one or more images or video frames. For example, the apparatus can include a camera (e.g., an RGB camera) or multiple cameras for capturing one or more images and/or one or more videos including video frames. In some aspects, the apparatus includes a display for displaying one or more images, videos, notifications, or other displayable data. In some aspects, the apparatus includes a transmitter configured to transmit data or information over a transmission medium to at least one device. In some aspects, the processor includes a central processing unit (CPU), a graphics processing unit (GPU), a neural processing unit (NPU), or other processing device or component.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and examples, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating an architecture of an image capture and processing system, in accordance with aspects of the present disclosure.

FIG. 2 is a diagram illustrating an architecture of an example extended reality (XR) system, in accordance with some aspects of the disclosure.

FIG. 3A-3D and FIG. 4 are diagrams illustrating examples of neural networks, in accordance with some examples.

FIG. 5 illustrates an obstructed view of a target area and views of the target area which deemphasize the obstructions, in accordance with aspects of the present disclosure.

FIG. 6 illustrates use of a drone as a remote sensor, in accordance with aspects of the present disclosure.

FIG. 7 is a flow diagram illustrating a technique for generating a 2D XR view using remote sensor, in accordance with aspects of the present disclosure.

FIG. 8 is a flow diagram illustrating a technique for generating a 3D reconstruction of an environment including a target area and a portion of an area between the target area and XR device using remote sensors, in accordance with aspects of the present disclosure.

FIG. 9 is a flow diagram illustrating another technique for generating a 2D XR view using remote sensor using remote sensors 900, in accordance with aspects of the present disclosure.

FIG. 10 is a flow diagram illustrating a process 1000 for rendering images for display by an extended reality device, in accordance with aspects of the present disclosure.

FIG. 11A is a perspective diagram illustrating a head-mounted display (HMD), in accordance with some examples.

FIG. 11B is a perspective diagram illustrating the head-mounted display (HMD) of FIG. 11A, in accordance with some examples.

FIG. 12A is a perspective diagram illustrating a front surface of a mobile device that can display XR content, in accordance with some examples.

FIG. 12B is a perspective diagram illustrating a rear surface of a mobile device 950, in accordance with aspects of the present disclosure.

FIG. 13 is a diagram illustrating an example of a system for implementing certain aspects of the present technology.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of subject matter of the application. However, it will be apparent that various examples may be practiced without these specific details. The figures and description are not intended to be restrictive.

The ensuing description provides illustrative examples only, and is not intended to limit the scope, applicability, or configuration of the disclosure. Rather, the ensuing description will provide those skilled in the art with an enabling description for implementing the illustrative examples. It should be understood that various changes may be made in the function and arrangement of elements without departing from the spirit and scope of the application as set forth in the appended claims.

Extended reality (XR) systems or devices can provide virtual content to a user and/or can combine real-world or physical environments and virtual environments (made up of virtual content) to provide users with XR experiences. The real-world environment can include real-world objects (also referred to as physical objects), such as people, vehicles, buildings, tables, chairs, and/or other real-world or physical objects. XR devices or systems can facilitate interaction with different types of XR environments (e.g., a user can use an XR device or system to interact with an XR environment). The terms XR system and XR device will be used herein interchangeably. An XR device or system can include virtual reality (VR) devices or systems facilitating interactions with VR environments, augmented reality (AR) devices or systems facilitating interactions with AR environments, mixed reality (MR) devices or systems facilitating interactions with MR environments, and/or other XR devices or systems. Examples of XR systems or devices include head-mounted displays (HMDs), smart glasses, among others. In some cases, an XR device can track parts of the user (e.g., a hand and/or fingertips of a user) to allow the user to interact with items of virtual content.

XR devices may generate virtual environments based on sensor data from one or more sensors of the XR device. For example, an XR device, such as an HMD, may include a plurality of cameras and the XR device may generate the virtual environment using images captured by the cameras. In some cases, a user of the XR device may be interested in viewing a target area, such as some event, but the view of the sensors of the XR device (e.g., a point of view of the person using the XR device) of the target area may be blocked by an obstacle, such as other people, trees, a pole, etc. In such cases, it may be useful to use remote sensors, such as one or more sensors of a drone flying overhead to provide a view of the event from a point of view of the XR device.

Systems, apparatuses, electronic devices, methods (also referred to as processes), and computer-readable media (collectively referred to herein as “systems and techniques”) are described herein for remote sensor assisted XR. For example, an XR device can receive and use sensor data received from one or more remote sensors, such as one or more cameras and/or other sensor(s) from a drone or other remote device. The remote sensor assisted XR can provide an XR device with a greater field of view, providing obstacle free line of sight among other benefits.

According to some aspects, remote sensors, such as a drone, may be useful to provide a view (e.g., view through the XR device) of a region of a real environment (e.g., target area) around an XR user that may not be observable (e.g., obscured/blocked) by cameras and/or other sensors of an XR device as these remote sensors may have a different line of sight (e.g., view of) to the target area. The XR device may receive the information associated with the obstructed target area from the remote sensor and integrate the information into a view for display by the XR device by generating a virtual representation of the target area and rendering the virtual representation for display, for example, by a display of the XR device. This remote sensor may be a drone, or may be a plurality of remote sensors distributed through the real environment. In some cases, a drone may be able to move around in the environment to provide views of areas of the environment that may not be viewable by a single static remote sensor. In some cases, multiple static remote sensors may be used to fill in gaps that may occur with a single static remote sensor. The information associated with the target area may be provided to the XR device in a form of images of the target area or the remote sensors may generate a 3-dimensional (3D) reconstruction of the target area and provide the 3D reconstruction to the XR device.

As an example, the drone may provide images of target area to the XR device. The XR device may determine a pose of the remote sensor, for example, using features of the images of the target area. In some cases, the remote sensor may provide their pose information and the XR device may skip determining the pose of the remote sensor. The XR device may transform the images of the target area from the perspective (e.g., point of view) of the remote sensor to a perspective of the XR device using a pose of the remote sensor and a pose of the XR device to generate a virtual representation of the target area and then render a view of the virtual representation that may be displayed, for example, by displays of an HMD.

As another example, the remote sensor may provide a 3D reconstruction of the target area based on images captured by the remote sensor. For example, the remote sensors may generate a truncated signed distance field (TSDF) function based on a plurality of images of the target area and generate a local mesh of the target area using the TSDF function. The remote sensor may provide the local mesh to the XR device as the information associated with the target area.

In another example, the drone may provide images of target area to the XR device and the XR device may use the images of the target area to train a neural radiance field (NeRF) model of the target area. Once trained, the XR device may render a virtual representation of the target by querying the NeRF model based on the pose of the XR device.

Various aspects of the application will be described with respect to the figures.

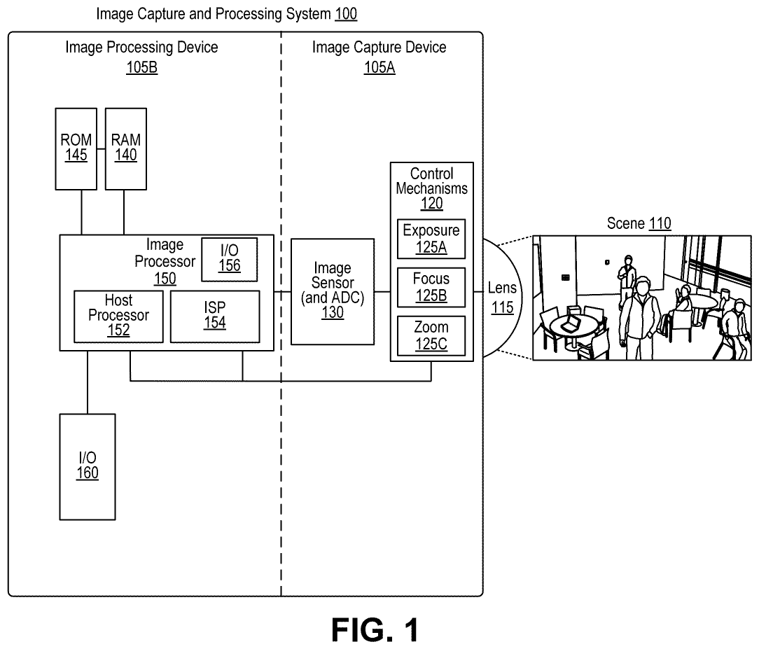

FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. In some cases, the lens 115 and image sensor 130 can be associated with an optical axis. In one illustrative example, the photosensitive area of the image sensor 130 (e.g., the photodiodes) and the lens 115 can both be centered on the optical axis. A lens 115 of the image capture and processing system 100 faces a scene 110 and receives light from the scene 110. The lens 115 bends incoming light from the scene toward the image sensor 130. The light received by the lens 115 passes through an aperture. In some cases, the aperture (e.g., the aperture size) is controlled by one or more control mechanisms 120 and is received by an image sensor 130. In some cases, the aperture can have a fixed size.

In some aspects, one or more of the apparatuses described herein comprises a mobile device (e.g., a mobile telephone or so-called “smart phone”, a tablet computer, or other type of mobile device), a wearable device, an extended reality device (e.g., a virtual reality (VR) device, an augmented reality (AR) device, or a mixed reality (MR) device), a personal computer, a laptop computer, a video server, a television (e.g., a network-connected television), a vehicle (or a computing device of a vehicle), or other device. In some aspects, the apparatus(es) includes at least one camera for capturing one or more images or video frames. For example, the apparatus(es) can include a camera (e.g., an RGB camera) or multiple cameras for capturing one or more images and/or one or more videos including video frames. In some aspects, the apparatus(es) includes at least one display for displaying one or more images, videos, notifications, or other displayable data. In some aspects, the apparatus(es) includes at least one transmitter configured to transmit one or more video frame and/or syntax data over a transmission medium to at least one device. In some aspects, the at least one processor includes a neural processing unit (NPU), a neural signal processor (NSP), a central processing unit (CPU), a graphics processing unit (GPU), any combination thereof, and/or other processing device or component.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo (or other lens mechanism), thereby adjusting focus. In some cases, additional lenses may be included in the image capture and processing system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), hybrid autofocus (HAF), or some combination thereof. The focus setting may be determined using the control mechanism 120, the image sensor 130, and/or the image processor 150. The focus setting may be referred to as an image capture setting and/or an image processing setting. In some cases, the lens 115 can be fixed relative to the image sensor and focus control mechanism 125B can be omitted without departing from the scope of the present disclosure.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 125C moves one or more of the lenses in the afocal zoom system, such as the negative lens and one or both of the positive lenses. In some cases, zoom control mechanism 125C can control the zoom by capturing an image from an image sensor of a plurality of image sensors (e.g., including image sensor 130) with a zoom corresponding to the zoom setting. For example, image processing system 100 can include a wide angle image sensor with a relatively low zoom and a telephoto image sensor with a greater zoom. In some cases, based on the selected zoom setting, the zoom control mechanism 125C can capture images from a corresponding sensor.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different filters. In some cases, different photodiodes can be covered in color filters, and the photodiodes may measure light matching the color of the filter covering the photodiode. Various color filter arrays can be used, including a Bayer color filter array, a quad color filter array (also referred to as a quad Bayer color filter array or QCFA), and/or any other color filter array. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter.

Returning to FIG. 1, other types of color filters may use yellow, magenta, and/or cyan (also referred to as “emerald”) color filters instead of or in addition to red, blue, and/or green color filters. In some cases, some photodiodes may be configured to measure infrared (IR) light. In some implementations, photodiodes measuring IR light may not be covered by any filter, thus allowing IR photodiodes to measure both visible (e.g., color) and IR light. In some examples, IR photodiodes may be covered by an IR filter, allowing IR light to pass through and blocking light from other parts of the frequency spectrum (e.g., visible light, color). Some image sensors (e.g., image sensor 130) may lack filters (e.g., color, IR, or any other part of the light spectrum) altogether and may instead use different photodiodes throughout the pixel array (in some cases vertically stacked). The different photodiodes throughout the pixel array can have different spectral sensitivity curves, therefore responding to different wavelengths of light. Monochrome image sensors may also lack filters and therefore lack color depth.

In some cases, the image sensor 130 may alternately or additionally include opaque and/or reflective masks that block light from reaching certain photodiodes, or portions of certain photodiodes, at certain times and/or from certain angles. In some cases, opaque and/or reflective masks may be used for phase detection autofocus (PDAF). In some cases, the opaque and/or reflective masks may be used to block portions of the electromagnetic spectrum from reaching the photodiodes of the image sensor (e.g., an IR cut filter, a UV cut filter, a band-pass filter, low-pass filter, high-pass filter, or the like). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

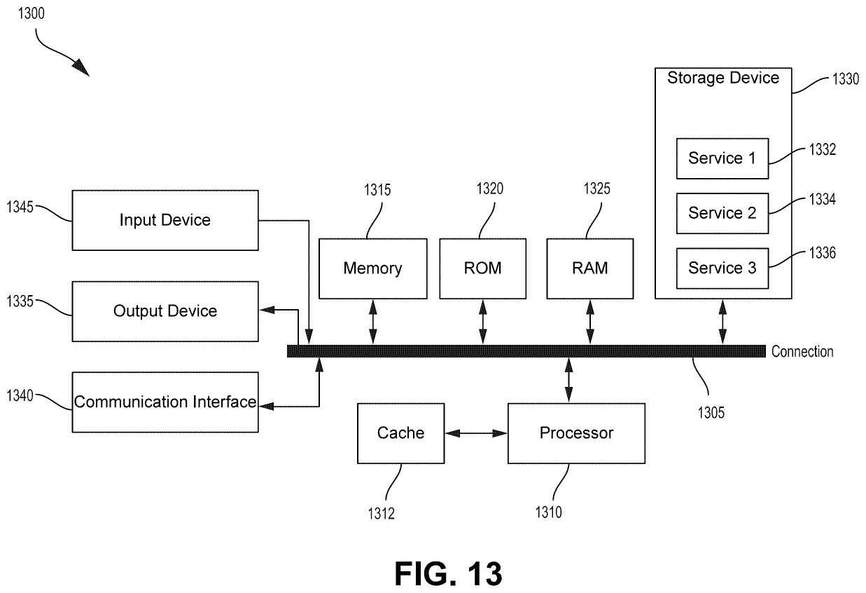

The image processor 150 may include one or more processors, such as one or more image signal processors (ISPs) (including ISP 154), one or more host processors (including host processor 152), and/or one or more of any other type of processor 1310 discussed with respect to the computing system 1300 of FIG. 13. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/1125, read-only memory (ROM) 145/1120, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices, any other input devices, or some combination thereof. In some cases, a caption may be input into the image processing device 105B through a physical keyboard or keypad of the I/O devices 160, or through a virtual keyboard or keypad of a touchscreen of the I/O devices 160. The I/O devices 160 may include one or more ports, jacks, or other connectors that enable a wired connection between the image capture and processing system 100 and one or more peripheral devices, over which the image capture and processing system 100 may receive data from the one or more peripheral device and/or transmit data to the one or more peripheral devices. The I/O devices 160 may include one or more wireless transceivers that enable a wireless connection between the image capture and processing system 100 and one or more peripheral devices, over which the image capture and processing system 100 may receive data from the one or more peripheral device and/or transmit data to the one or more peripheral devices. The peripheral devices may include any of the previously discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O devices 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

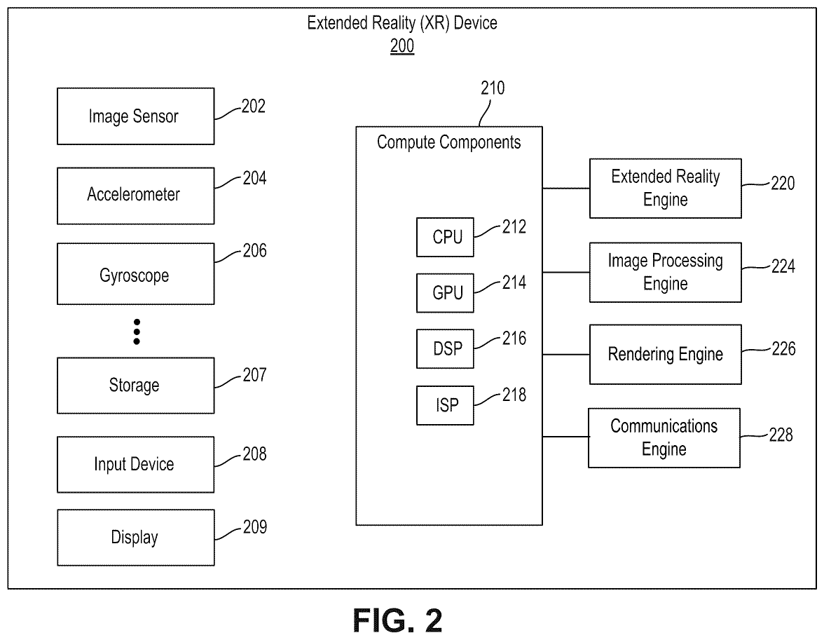

In some examples, the extended reality (XR) device 200 of FIG. 2 can include the image capture and processing system 100, the image capture device 105A, the image processing device 105B, or a combination thereof.

FIG. 2 is a diagram illustrating an architecture of an example extended reality (XR) device 200, in accordance with some aspects of the disclosure. The XR device 200 can run (or execute) XR applications and implement XR operations. In some examples, the XR device 200 can perform tracking and localization, mapping of an environment in the physical world (e.g., a scene), and/or positioning and rendering of virtual content on a display 209 (e.g., a screen, visible plane/region, and/or other display) as part of an XR experience. For example, the XR device 200 can generate a map (e.g., a three-dimensional (3D) map) of an environment in the physical world, track a pose (e.g., location and position) of the XR device 200 relative to the environment (e.g., relative to the 3D map of the environment), position and/or anchor virtual content in a specific location(s) on the map of the environment, and render the virtual content on the display 209 such that the virtual content appears to be at a location in the environment corresponding to the specific location on the map of the scene where the virtual content is positioned and/or anchored. The display 209 can include a glass, a screen, a lens, a projector, and/or other display mechanism that allows a user to see the real-world environment and also allows XR content to be overlaid, overlapped, blended with, or otherwise displayed thereon.

In this illustrative example, the XR device 200 includes one or more image sensors 202, an accelerometer 204, a gyroscope 206, storage 207, compute components 210, an XR engine 220, an image processing engine 224, a rendering engine 226, and a communications engine 228. It should be noted that the components 202-228 shown in FIG. 2 are non-limiting examples provided for illustrative and explanation purposes, and other examples can include more, fewer, or different components than those shown in FIG. 2. For example, in some cases, the XR device 200 can include one or more other sensors (e.g., one or more inertial measurement units (IMUs), radars, light detection and ranging (LIDAR) sensors, radio detection and ranging (RADAR) sensors, sound detection and ranging (SODAR) sensors, sound navigation and ranging (SONAR) sensors. audio sensors, etc.), one or more display devices, one more other processing engines, one or more other hardware components, and/or one or more other software and/or hardware components that are not shown in FIG. 2. While various components of the XR device 200, such as the image sensor 202, may be referenced in the singular form herein, it should be understood that the XR device 200 may include multiple of any component discussed herein (e.g., multiple image sensors 202).

The XR device 200 includes or is in communication with (wired or wirelessly) an input device 208. The input device 208 can include any suitable input device, such as a touchscreen, a pen or other pointer device, a keyboard, a mouse a button or key, a microphone for receiving voice commands, a gesture input device for receiving gesture commands, a video game controller, a steering wheel, a joystick, a set of buttons, a trackball, a remote control, any other input device 1145 discussed herein, or any combination thereof. In some cases, the image sensor 202 can capture images that can be processed for interpreting gesture commands.

The XR device 200 can also communicate with one or more other electronic devices (wired or wirelessly). For example, communications engine 228 can be configured to manage connections and communicate with one or more electronic devices. In some cases, the communications engine 228 can correspond to the communications interface 1340 of FIG. 13.

In some implementations, the one or more image sensors 202, the accelerometer 204, the gyroscope 206, storage 207, compute components 210, XR engine 220, image processing engine 224, and rendering engine 226 can be part of the same computing device. For example, in some cases, the one or more image sensors 202, the accelerometer 204, the gyroscope 206, storage 207, compute components 210, XR engine 220, image processing engine 224, and rendering engine 226 can be integrated into an HMD, extended reality glasses, smartphone, laptop, tablet computer, gaming system, and/or any other computing device. However, in some implementations, the one or more image sensors 202, the accelerometer 204, the gyroscope 206, storage 207, compute components 210, XR engine 220, image processing engine 224, and rendering engine 226 can be part of two or more separate computing devices. For example, in some cases, some of the components 202-226 can be part of, or implemented by, one computing device and the remaining components can be part of, or implemented by, one or more other computing devices.

The storage 207 can be any storage device(s) for storing data. Moreover, the storage 207 can store data from any of the components of the XR device 200. For example, the storage 207 can store data from the image sensor 202 (e.g., image or video data), data from the accelerometer 204 (e.g., measurements), data from the gyroscope 206 (e.g., measurements), data from the compute components 210 (e.g., processing parameters, preferences, virtual content, rendering content, scene maps, tracking and localization data, object detection data, privacy data, XR application data, face recognition data, occlusion data, etc.), data from the XR engine 220, data from the image processing engine 224, and/or data from the rendering engine 226 (e.g., output frames). In some examples, the storage 207 can include a buffer for storing frames for processing by the compute components 210.

The one or more compute components 210 can include a central processing unit (CPU) 212, a graphics processing unit (GPU) 214, a digital signal processor (DSP) 216, an image signal processor (ISP) 218, and/or other processor (e.g., a neural processing unit (NPU) implementing one or more trained neural networks). The compute components 210 can perform various operations such as image enhancement, computer vision, graphics rendering, extended reality operations (e.g., tracking, localization, pose estimation, mapping, content anchoring, content rendering, etc.), image and/or video processing, sensor processing, recognition (e.g., text recognition, facial recognition, object recognition, feature recognition, tracking or pattern recognition, scene recognition, occlusion detection, etc.), trained machine learning operations, filtering, and/or any of the various operations described herein. In some examples, the compute components 210 can implement (e.g., control, operate, etc.) the XR engine 220, the image processing engine 224, and the rendering engine 226. In other examples, the compute components 210 can also implement one or more other processing engines.

The image sensor 202 can include any image and/or video sensors or capturing devices. In some examples, the image sensor 202 can be part of a multiple-camera assembly, such as a dual-camera assembly. The image sensor 202 can capture image and/or video content (e.g., raw image and/or video data), which can then be processed by the compute components 210, the XR engine 220, the image processing engine 224, and/or the rendering engine 226 as described herein. In some examples, the image sensors 202 may include an image capture and processing system 100, an image capture device 105A, an image processing device 105B, or a combination thereof.

In some examples, the image sensor 202 can capture image data and can generate images (also referred to as frames) based on the image data and/or can provide the image data or frames to the XR engine 220, the image processing engine 224, and/or the rendering engine 226 for processing. An image or frame can include a video frame of a video sequence or a still image. An image or frame can include a pixel array representing a scene. For example, an image can be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image.

In some cases, the image sensor 202 (and/or other camera of the XR device 200) can be configured to also capture depth information. For example, in some implementations, the image sensor 202 (and/or other camera) can include an RGB-depth (RGB-D) camera. In some cases, the XR device 200 can include one or more depth sensors (not shown) that are separate from the image sensor 202 (and/or other camera) and that can capture depth information. For instance, such a depth sensor can obtain depth information independently from the image sensor 202. In some examples, a depth sensor can be physically installed in the same general location as the image sensor 202, but may operate at a different frequency or frame rate from the image sensor 202. In some examples, a depth sensor can take the form of a light source that can project a structured or textured light pattern, which may include one or more narrow bands of light, onto one or more objects in a scene. Depth information can then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

The XR device 200 can also include other sensors in its one or more sensors. The one or more sensors can include one or more accelerometers (e.g., accelerometer 204), one or more gyroscopes (e.g., gyroscope 206), and/or other sensors. The one or more sensors can provide velocity, orientation, and/or other position-related information to the compute components 210. For example, the accelerometer 204 can detect acceleration by the XR device 200 and can generate acceleration measurements based on the detected acceleration. In some cases, the accelerometer 204 can provide one or more translational vectors (e.g., up/down, left/right, forward/back) that can be used for determining a position or pose of the XR device 200. The gyroscope 206 can detect and measure the orientation and angular velocity of the XR device 200. For example, the gyroscope 206 can be used to measure the pitch, roll, and yaw of the XR device 200. In some cases, the gyroscope 206 can provide one or more rotational vectors (e.g., pitch, yaw, roll). In some examples, the image sensor 202 and/or the XR engine 220 can use measurements obtained by the accelerometer 204 (e.g., one or more translational vectors) and/or the gyroscope 206 (e.g., one or more rotational vectors) to calculate the pose of the XR device 200. As previously noted, in other examples, the XR device 200 can also include other sensors, such as an inertial measurement unit (IMU), a magnetometer, a gaze and/or eye tracking sensor, a machine vision sensor, a smart scene sensor, a speech recognition sensor, an impact sensor, a shock sensor, a position sensor, a tilt sensor, etc.

As noted above, in some cases, the one or more sensors can include at least one IMU. An IMU is an electronic device that measures the specific force, angular rate, and/or the orientation of the XR device 200, using a combination of one or more accelerometers, one or more gyroscopes, and/or one or more magnetometers. In some examples, the one or more sensors can output measured information associated with the capture of an image captured by the image sensor 202 (and/or other camera of the XR device 200) and/or depth information obtained using one or more depth sensors of the XR device 200.

The output of one or more sensors (e.g., the accelerometer 204, the gyroscope 206, one or more IMUs, and/or other sensors) can be used by the XR engine 220 to determine a pose of the XR device 200 (also referred to as the head pose) and/or the pose of the image sensor 202 (or other camera of the XR device 200). In some cases, the pose of the XR device 200 and the pose of the image sensor 202 (or other camera) can be the same. The pose of image sensor 202 refers to the position and orientation of the image sensor 202 relative to a frame of reference (e.g., with respect to the scene 110). In some implementations, the camera pose can be determined for 6-Degrees of Freedom (6DoF), which refers to three translational components (e.g., which can be given by X (horizontal), Y (vertical), and Z (depth) coordinates relative to a frame of reference, such as the image plane) and three angular components (e.g. roll, pitch, and yaw relative to the same frame of reference). In some implementations, the camera pose can be determined for 3-Degrees of Freedom (3DoF), which refers to the three angular components (e.g. roll, pitch, and yaw).

In some cases, a device tracker (not shown) can use the measurements from the one or more sensors and image data from the image sensor 202 to track a pose (e.g., a 6DoF pose) of the XR device 200. For example, the device tracker can fuse visual data (e.g., using a visual tracking solution) from the image data with inertial data from the measurements to determine a position and motion of the XR device 200 relative to the physical world (e.g., the scene) and a map of the physical world. As described below, in some examples, when tracking the pose of the XR device 200, the device tracker can generate a three-dimensional (3D) map of the scene (e.g., the real world) and/or generate updates for a 3D map of the scene. The 3D map updates can include, for example and without limitation, new or updated features and/or feature or landmark points associated with the scene and/or the 3D map of the scene, localization updates identifying or updating a position of the XR device 200 within the scene and the 3D map of the scene, etc. The 3D map can provide a digital representation of a scene in the real/physical world. In some examples, the 3D map can anchor location-based objects and/or content to real-world coordinates and/or objects. The XR device 200 can use a mapped scene (e.g., a scene in the physical world represented by, and/or associated with, a 3D map) to merge the physical and virtual worlds and/or merge virtual content or objects with the physical environment.

In some aspects, the pose of image sensor 202 and/or the XR device 200 as a whole can be determined and/or tracked by the compute components 210 using a visual tracking solution based on images captured by the image sensor 202 (and/or other camera of the XR device 200). For instance, in some examples, the compute components 210 can perform tracking using computer vision-based tracking, model-based tracking, and/or simultaneous localization and mapping (SLAM) techniques. For instance, the compute components 210 can perform SLAM or can be in communication (wired or wireless) with a SLAM system (not shown). SLAM refers to a class of techniques where a map of an environment (e.g., a map of an environment being modeled by XR device 200) is created while simultaneously tracking the pose of a camera (e.g., image sensor 202) and/or the XR device 200 relative to that map. The map can be referred to as a SLAM map, and can be three-dimensional (3D). The SLAM techniques can be performed using color or grayscale image data captured by the image sensor 202 (and/or other camera of the XR device 200), and can be used to generate estimates of 6DoF pose measurements of the image sensor 202 and/or the XR device 200. Such a SLAM technique configured to perform 6DoF tracking can be referred to as 6DoF SLAM. In some cases, the output of the one or more sensors (e.g., the accelerometer 204, the gyroscope 206, one or more IMUs, and/or other sensors) can be used to estimate, correct, and/or otherwise adjust the estimated pose.

In some cases, the 6DoF SLAM (e.g., 6DoF tracking) can associate features observed from certain input images from the image sensor 202 (and/or other camera) to the SLAM map. For example, 6DoF SLAM can use feature point associations from an input image to determine the pose (position and orientation) of the image sensor 202 and/or XR device 200 for the input image. 6DoF mapping can also be performed to update the SLAM map. In some cases, the SLAM map maintained using the 6DoF SLAM can contain 3D feature points triangulated from two or more images. For example, key frames can be selected from input images or a video stream to represent an observed scene. For every key frame, a respective 6DoF camera pose associated with the image can be determined. The pose of the image sensor 202 and/or the XR device 200 can be determined by projecting features from the 3D SLAM map into an image or video frame and updating the camera pose from verified 2D-3D correspondences.

In one illustrative example, the compute components 210 can extract feature points from certain input images (e.g., every input image, a subset of the input images, etc.) or from each key frame. A feature point (also referred to as a registration point) as used herein is a distinctive or identifiable part of an image, such as a part of a hand, an edge of a table, among others. Features extracted from a captured image can represent distinct feature points along three-dimensional space (e.g., coordinates on X, Y, and Z-axes), and every feature point can have an associated feature location. The feature points in key frames either match (are the same or correspond to) or fail to match the feature points of previously captured input images or key frames. Feature detection can be used to detect the feature points. Feature detection can include an image processing operation used to examine one or more pixels of an image to determine whether a feature exists at a particular pixel. Feature detection can be used to process an entire captured image or certain portions of an image. For each image or key frame, once features have been detected, a local image patch around the feature can be extracted. Features may be extracted using any suitable technique, such as Scale Invariant Feature Transform (SIFT) (which localizes features and generates their descriptions), Learned Invariant Feature Transform (LIFT), Speed Up Robust Features (SURF), Gradient Location-Orientation histogram (GLOH), Oriented Fast and Rotated Brief (ORB), Binary Robust Invariant Scalable Keypoints (BRISK), Fast Retina Keypoint (FREAK), KAZE, Accelerated KAZE (AKAZE), Normalized Cross Correlation (NCC), descriptor matching, another suitable technique, or a combination thereof.

As one illustrative example, the compute components 210 can extract feature points corresponding to a mobile device, or the like. In some cases, feature points corresponding to the mobile device can be tracked to determine a pose of the mobile device. As described in more detail below, the pose of the mobile device can be used to determine a location for projection of AR media content that can enhance media content displayed on a display of the mobile device.

In some cases, the XR device 200 can also track the hand and/or fingers of the user to allow the user to interact with and/or control virtual content in a virtual environment. For example, the XR device 200 can track a pose and/or movement of the hand and/or fingertips of the user to identify or translate user interactions with the virtual environment. The user interactions can include, for example and without limitation, moving an item of virtual content, resizing the item of virtual content, selecting an input interface element in a virtual user interface (e.g., a virtual representation of a mobile phone, a virtual keyboard, and/or other virtual interface), providing an input through a virtual user interface, etc.

A neural network is an example of a machine learning system, and a neural network can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

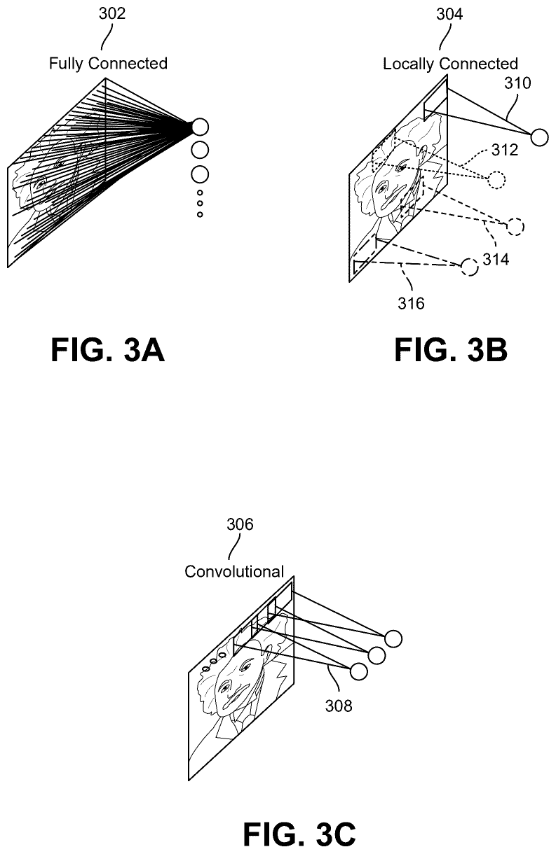

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input. The connections between layers of a neural network may be fully connected or locally connected. Various examples of neural network architectures are described below with respect to FIG. 3A-FIG. 4.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

The connections between layers of a neural network may be fully connected or locally connected. FIG. 3A illustrates an example of a fully connected neural network 302. In a fully connected neural network 302, a neuron in a first layer may communicate its output to every neuron in a second layer, so that each neuron in the second layer will receive input from every neuron in the first layer. FIG. 3B illustrates an example of a locally connected neural network 304. In a locally connected neural network 304, a neuron in a first layer may be connected to a limited number of neurons in the second layer. More generally, a locally connected layer of the locally connected neural network 304 may be configured so that each neuron in a layer will have the same or a similar connectivity pattern, but with connections strengths that may have different values (e.g., 310, 312, 314, and 316). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 3C illustrates an example of a convolutional neural network 306. The convolutional neural network 306 may be configured such that the connection strengths associated with the inputs for each neuron in the second layer are shared (e.g., 308). Convolutional neural networks may be well suited to problems in which the spatial location of inputs is meaningful. Convolutional neural network 306 may be used to perform one or more aspects of video compression and/or decompression, according to aspects of the present disclosure.

One type of convolutional neural network is a deep convolutional network (DCN). FIG. 3D illustrates a detailed example of a DCN 300 designed to recognize visual features from an image 326 input from an image capturing device 330, such as a car-mounted camera. The DCN 300 of the current example may be trained to identify traffic signs and a number provided on the traffic sign. Of course, the DCN 300 may be trained for other tasks, such as identifying lane markings, identifying traffic lights, detecting people and/or objects, etc.

The DCN 300 may be trained with supervised learning. During training, the DCN 300 may be presented with an image, such as the image 326 of a speed limit sign, and a forward pass may then be computed to produce an output 322. The DCN 300 may include a feature extraction section and a classification section. Upon receiving the image 326, a convolutional layer 332 may apply convolutional kernels (not shown) to the image 326 to generate a first set of feature maps 318. As an example, the convolutional kernel for the convolutional layer 332 may be a 5×5 kernel that generates 28×28 feature maps. In the present example, because four different feature maps are generated in the first set of feature maps 318, four different convolutional kernels were applied to the image 326 at the convolutional layer 332. The convolutional kernels may also be referred to as filters or convolutional filters.

The first set of feature maps 318 may be subsampled by a max pooling layer (not shown) to generate a second set of feature maps 320. The max pooling layer reduces the size of the first set of feature maps 318. That is, a size of the second set of feature maps 320, such as 14×14, is less than the size of the first set of feature maps 318, such as 28×28. The reduced size provides similar information to a subsequent layer while reducing memory consumption. The second set of feature maps 320 may be further convolved via one or more subsequent convolutional layers (not shown) to generate one or more subsequent sets of feature maps (not shown).

In the example of FIG. 3D, the second set of feature maps 320 is convolved to generate a first feature vector 324. Furthermore, the first feature vector 324 is further convolved to generate a second feature vector 328. Each feature of the second feature vector 328 may include a number that corresponds to a possible feature of the image 326, such as “sign,” “60,” and “100.” A softmax function (not shown) may convert the numbers in the second feature vector 328 to a probability. As such, an output 322 of the DCN 300 is a probability of the image 326 including one or more features.

In the present example, the probabilities in the output 322 for “sign” and “60” are higher than the probabilities of the others of the output 322, such as “30,” “40,” “50,” “70,” “80,” “90,” and “100”. Before training, the output 322 produced by the DCN 300 is likely to be incorrect. Thus, an error may be calculated between the output 322 and a target output. The target output is the ground truth of the image 326 (e.g., “sign” and “60”). The weights of the DCN 300 may then be adjusted so the output 322 of the DCN 300 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output 322 that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., feature maps 320) receiving input from a range of neurons in the previous layer (e.g., feature maps 318) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction.

FIG. 4 is a block diagram illustrating an example of a deep convolutional network 450. The deep convolutional network 450 may include multiple different types of layers based on connectivity and weight sharing. As shown in FIG. 4, the deep convolutional network 450 includes the convolution blocks 454A, 454B. Each of the convolution blocks 454A, 454B may be configured with a convolution layer (CONV) 456, a normalization layer (LNorm) 458, and a max pooling layer (MAX POOL) 460.

The convolution layers 456 may include one or more convolutional filters, which may be applied to the input data 452 to generate a feature map. Although only two convolution blocks 454A, 454B are shown, the present disclosure is not so limiting, and instead, any number of convolution blocks (e.g., convolution blocks 454A, 454B) may be included in the deep convolutional network 450 according to design preference. The normalization layer 458 may normalize the output of the convolution filters. For example, the normalization layer 458 may provide whitening or lateral inhibition. The max pooling layer 460 may provide down sampling aggregation over space for local invariance and dimensionality reduction.

The parallel filter banks, for example, of a deep convolutional network may be loaded on a CPU 212 or GPU 214 of the compute components 210 to achieve high performance and low power consumption. In alternative aspects, the parallel filter banks may be loaded on the DSP 216 or an ISP 218 of the compute components 210. In addition, the deep convolutional network 450 may access other processing blocks that may be present on the compute components 210, such as sensor processor and navigation module, dedicated, respectively, to sensors and navigation.

The deep convolutional network 450 may also include one or more fully connected layers, such as layer 462A (labeled “FC1”) and layer 462B (labeled “FC2”). The deep convolutional network 450 may further include a logistic regression (LR) layer 464. Between each layer 456, 458, 460, 462A, 462B, 464 of the deep convolutional network 450 are weights (not shown) that are to be updated. The output of each of the layers (e.g., 456, 458, 460, 462A, 462B, 464) may serve as an input of a succeeding one of the layers (e.g., 456, 458, 460, 462A, 462B, 464) in the deep convolutional network 450 to learn hierarchical feature representations from input data 452 (e.g., images, audio, video, sensor data and/or other input data) supplied at the first of the convolution blocks 454A. The output of the deep convolutional network 450 is a classification score 466 for the input data 452. The classification score 466 may be a set of probabilities, where each probability is the probability of the input data including a feature from a set of features.

As previously described, a view of cameras and/or other sensors of an XR device (e.g., a point of view of the person using the XR device) of a target area may be blocked by one or more obstacle. In such cases, it may be useful to provide a view (e.g., view through the XR device) of a region of an environment around the XR device that may not be observable (e.g., obscured/blocked) from cameras and/or other sensors of an XR device 506.

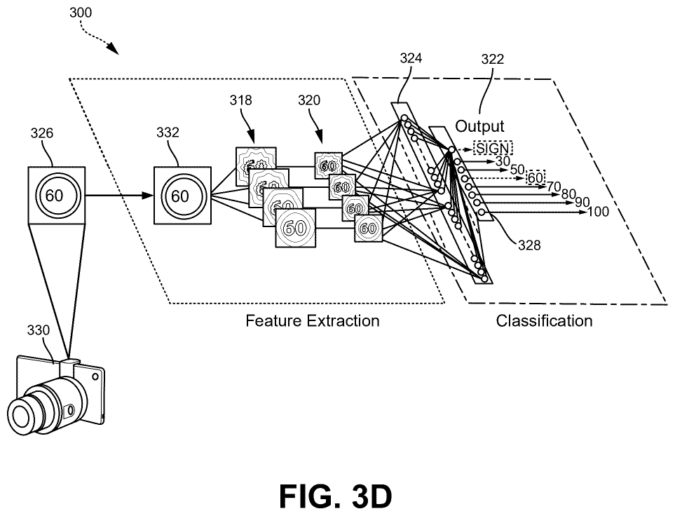

FIG. 5 is a diagram illustrating an example of a user with an XR device located at an event (e.g., a target of interest). The XR device has a view 502 of a target of interest 504 at the event blocked by obstacles/other persons. In such cases, it may be useful to use remote sensors from other devices, such as a drone flying overhead to provide a view of the event. The XR device may receive the information from the remote sensor, such as image information, and integrate the information into a view for display by the XR device. In some cases, the remote sensor may have a broader field of view as compared to sensors on the XR device 506 itself and this broader field of view may be used to form a more comprehensive reconstruction of the environment in the XR space. Based on 6DoF information form the XR device and a designated target of interest 504, the XR device 506 may be able to generate an unobstructed 2D projection of the target of interest in XR space that allows for an immersive view target of interest. This immersive view may be displayed as if the obstructions were not present in view 508 and the immersive view would not be experienced from the point of view of the remote sensor, but from the point of view of the XR device. In some cases, the immersive view may deemphasize the obstacles 510 to provide a view of the target of interest.

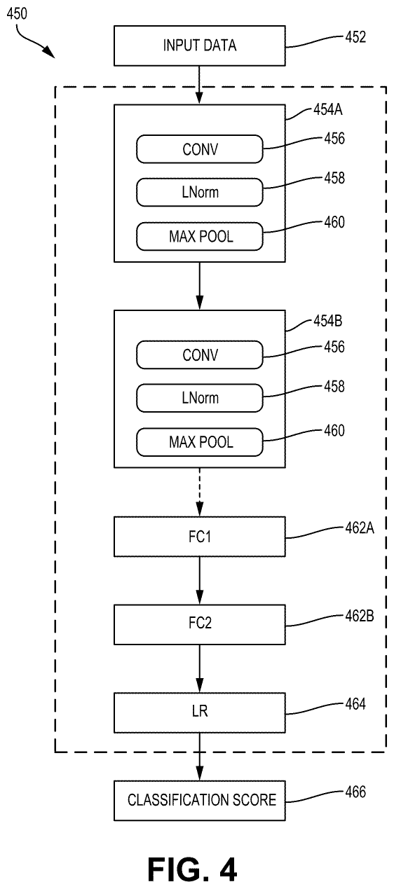

FIG. 6 illustrates use of a drone as a remote sensor 600, in accordance with aspects of the present disclosure. In some cases, the remote sensor may be a personal or shared drone 602 that may move around in the environment independently of the XR device, such as an HMD 604. As the drone 602 may be able to move around in the environment, the drone 602 may be able to provide views of areas of the environment that may not be captured by a single static sensor. For example, if a static sensor is to one side of a target object, the static sensor may not have a view of the other side of the target object. However, the drone 602 may be able to move 606 from one side to the other side to obtain additional views of the target object to aid reconstruction of the target object.

In some cases, the drone 602 may be able to provide additional computational resources to assist the HMD 604. For example, processes which may use more compute resources, such as full scene 3D rendering, 3D reconstruction, body pose estimation, object tracking, etc. may be offloaded to the drone 602 from the HMD 604. In some cases, motion of the drone 602 may also allow structure from motion to be used for 3D reconstruction/3D rendering that may not be available with static sensors. Output from the processes may be output from the drone 602 to the HMD 604, for example, for integration with an XR scene. Offloading some processing to the drone 602 may help reduce power consumption of the HMD 604 to help extend battery life and/or reduce heat produced by the HMD 604.

In some cases, such as for a prepared event such as a sports game, concert, etc., multiple non-drone-based sensors may also be used, such as static sensors, sensors on guide wires, etc. The non-drone-based sensors may be used instead of, or in conjunction with one or more drones. In some cases, the drones may be shared between multiple XR users. In some cases, different types of sensors may be used as well, such as color cameras, monochrome cameras, infrared cameras, depth sensors, etc.

In some cases, a remote sensor assisted XR view of a target area may be rendered as a 2D view of the target area (e.g., as if the target area is being viewed through a screen). Such a remote sensor assisted XR view may be rendered from a point of view of the XR device, such as an HMD. In some cases, the remote sensor assisted XR view of the target area may be rendered over/without any intermediate obstacles (e.g., as in view 508 of FIG. 5). In some cases, rendering the target area in 2D without intermediate obstacles may be useful for environments with a large number of objects such that 3D modeling such an environment may be too computational expensive to perform. The XR view may refer to a view of an area presented in the XR environment displayed by the XR display. The XR environment may refer to the virtual (e.g., logical) environment that may be displayed by the XR device and the XR environment may include virtual objects which correspond to objects in the real environment around the XR device as well as virtual objects that are only in the XR environment.

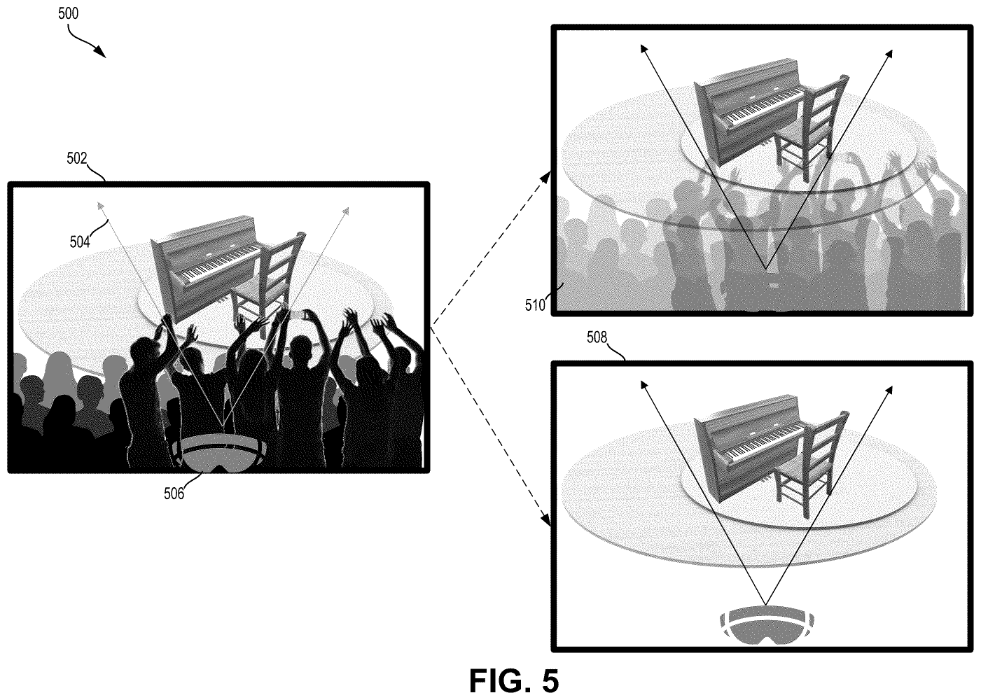

FIG. 7 is a flow diagram illustrating a technique for generating a 2D XR view using remote sensor 700, in accordance with aspects of the present disclosure. In some cases, a XR device, such as an HMD, companion device, etc., may be electronically coupled (e.g., via a network connection) to one or more drones 702A, . . . 702N (collectively drones 702). The XR device may receive information associated with a target area of the real environment around the XR device from the drones 702. For example, the drones 702 may transmit a set of images to the XR device. In some cases, the drones 702 may also transmit their pose information to the XR device. In cases where the set of images are provided to the XR device without pose information, the XR device may perform feature extraction/matching 706 on images of the set of images to determine the pose of the drones 702. For example, the XR device may extract features using any suitable technique, such as SIFT, LIFT, SURF, GLOH, ORB, BRISK, etc. Once extracted, the XR device may match the extracted features from the drones 702 to features of a SLAM map of the XR device to perform 6DoF SLAM to determine a pose of the drones 702.

In some cases, the drones 702 may transmit pose information indicating the position and orientation of the drones 702 when the images of the set of images were taken. For example, the drones 702 may include an IMU and/or configured to perform SLAM/VSLAM to determine the pose of the drones 702 in the environment. In cases where the pose of the drones 702 are available, the XR device may receive the set of images and pose and determine a homography matrix 708. In some cases, the homography matrix describes a transformation between a planar projection of an image from a drone 702 to a planar projection of an image from the XR device. For example, the view from the XR device's point of view may be described as a first planar projection. Similarly, the view from a point of view of a drone 702 as a second planar projection.

The homography matrix 708 describes transformations that may be applied to reproject the second planar projection based on the first planar projection. The homography matrix 708 may be determined to allow the images from the XR device to be reprojected (e.g., transformed/warped) so that they appear from the perspective (e.g., point of view) of the XR device. For example, coordinates of a pixel of an image from a drone 702 may be multiplied by the homography matrix 708 to determine coordinates of the pixel relative to an image of the XR device (e.g., reproject the pixel) and the reprojected pixel from the drone 702 may be substituted for the corresponding pixel from the XR device, for example, in a virtual representation of the target area (e.g., in an XR virtual environment). In some cases, a difference in corresponding pixels between the XR device and the reprojected pixel from the drones 702 to generate a translucent effect for the obstacles in view of the XR device. In some cases, the XR device may transmit pose and/or location information for the XR device to the drones 702 and the drones 702 may determine the homography matrix 708.

Exposure compensation 710 may be performed to adjust the color/exposure of the images from the drones 702. Any suitable technique for color correction/exposure correction may be applied. In some cases, the color correction/exposure correction may be applied to portions of the images from the drones 702 that may be displayed by the XR device. After color correction/exposure correction, the images from the drones 702 may be stitched 712 with images to be displayed by the XR device, for example, over any intermediate objects between the XR device and the target area to render images for display by the XR device. In some cases, where multiple drones 702 are used, the drones may have different pre-assigned tasks. For example, a first drone may be assigned for obtaining an overall view of the target area, while other drones may be assigned to perform gap filling by maneuvering around to obtain images of areas obscured from the first drone. In some cases, the drones 902 may also capture images of the XR device user and images of the XR device user may be used, for example, to provide body tracking (e.g., for animating an avatar), action recognition, etc.

In some cases, it may be useful to recognize and/or render objects in the environment into the XR environment. For example, in certain use cases, such as when the user of the XR device is expected to move through the real environment, such as walking, hiking, biking, etc., displaying a view of the target area over obstacles may result in the user being less aware of the obstacles, making collisions with the obstacles more likely. In some cases, performing a 3D reconstruction of the environment including the target area and at least a portion of an area between the XR device and the target area may be used to provide an awareness of obstacles by allowing the obstacles to be displayed in a deemphasized manner (e.g., in outline form, translucently, shadowed, etc.) as shown in deemphasized obstacles 510 of FIG. 5. Additionally, by generating a 3D reconstruction of the environment may allow virtual objects to be more easily added to the virtual environment, such as a marker over an object of interest in the target area.

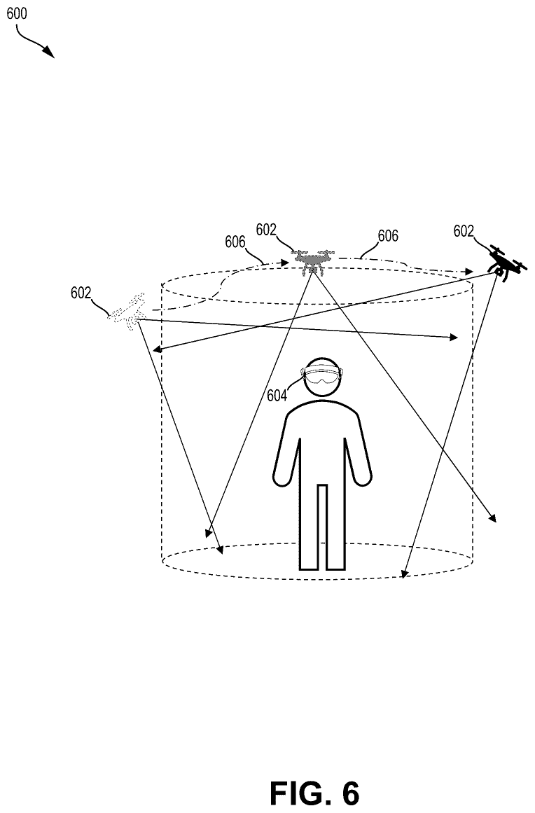

FIG. 8 is a flow diagram illustrating a technique for generating a 3D reconstruction of an environment including a target area and a portion of an area between the target area and XR device using remote sensors 800, in accordance with aspects of the present disclosure. As in FIG. 7, the XR device may be electronically coupled to one or more drones 802A, . . . 802N (collectively drones 802). The drones 802 may obtain images of the target area and/or portions of an area between the target area and XR device (e.g., a portion of the environment within view of the drones 802), along with depth information corresponding to the images. The depth information may be generated using any technique. For example, the drones 802 may include depth sensors to obtain the depth information. Alternatively, the drones 802 may use stereo imaging based depth sensing, monocular depth sensing, motion based depth sensing, ML model based depth sensing, any combination thereof, etc.

In some cases, rather than transmitting the set of images and depth information, the drones 802 may perform a 3D reconstruction 804A, . . . 804N (collectively, reconstructions 804) and generate a local mesh of a portion of the environment within view of the drones 802. The drone 802 may transmit the local mesh to the XR device as information associated with the target area of the real environment. Each drone 802 may independently generate the local mesh of the portion of the environment within view of the drone 802. The local mesh may be a mesh representation of the portion of the environment in the view of a drone 802. In some cases, the 3D reconstruction may be based on a global coordinate system.

In some cases, the drones 802 may perform the 3D reconstruction using any known technique. For example, the drones 802 may generate a truncated signed distance field (TSDF), which may be a 3D voxel array representing a volume (e.g., the sum total area of the environment being reconstructed), where voxels of the voxel array are labelled with information associated with (e.g., describing) surfaces of objects in the environment based on the pose of the drones 802 and the depth information. In some cases, the TSDF may be generated using computer vision based (e.g., conventional) algorithms or ML models. As an example, the drones 802 may project an image into 3D space, for example, using the depth information and selecting volume blocks (e.g., block of voxels) in which a pixel of an image captured by the drones 802 may be in based on the depth information. The selected voxels may be voxels which have a surface of an object in the voxels based on the depth information the TSDF may be generated by converting the depth information into a TSDF function. In some cases, the drones 802 may include hardware accelerators for generating the TSDF. A local mesh may be generated based on the TSDF, for example, using a marching cubes algorithm. In some cases, the drones 802 may use ML models to directly generate (e.g., predict) the local mesh. The drones 802 may transmit the local mesh to the XR device.

In some cases, the drones 802 may transmit the images of the portion of the environment within view of the drones 802 to the XR device along with pose information for the drones 802 and depth information (e.g., depth map) corresponding with images of the set of images. The XR device may then perform the 3D reconstructions 804 to generate a local mesh for each drone. The XR device may generate the local meshes in a manner substantially similar those discussed above with respect to the drone performing the 3D reconstructions 804 to generate a local meshes.

In some cases, the drones 802 may transmit the set of images, pose information, and depth information to a device separate from the XR device, such as a computing node, and the computing node may perform the 3D reconstruction 804 and generate the local meshes. For example, the computing node may be provided by a party that controls the drones 802 and the computing node may generate the local meshes based on sets of images provided by multiple drones 802. In some cases, the computing node may generate the local meshes in a manner substantially similar those discussed above with respect to the drone performing the 3D reconstructions 804 to generate a local meshes. In some cases, the computing node may merge the local meshes for the drones 802 into a single local mesh. The computing node may then transmit the local meshes (or single merged local mesh) to the XR device.

In some cases, the XR device may generate a local mesh based on a view from the XR device's sensors. The XR device may receive the local mesh(es) corresponding to the views from the drones 802 and fuse the local meshes to generate a global mesh 806. For example, the pose information from the drones 802 and the XR device may indicate where the generated local meshes of the drones 802 and the XR device are located relative to the global coordinate system. The generated local meshes may thus be rotated and merged with the global mesh 806. The global mesh 806 may be a virtual representation of the portion of the real environment including the target area and portion of real environment between the XR device and the target area.

The global mesh 806 may include the obstacles between the XR device and the target area (e.g., based on images captured either by the XR device or the drones 802). Based on a XR device pose 814 and a location of the target area 816, obstacles between the XR device and the target area may be detected and removed 808. In some cases, obstacles may be detected and removed 808 by assigning a zero density to the obstructing 3D surfaces corresponding to objects (e.g., obstacles) between the XR device and the target area. The objects may then appear as fully or partially transparent. In some cases, the density and/or transparency level may be dynamically adjusted (e.g., based on a user preference, preset, etc.).

After obstacle detection and removal 808, a 2D rendering of the global mesh 812 may be performed based on the XR device pose 818 and XR device camera intrinsic matrix 820 to render a 2D view of the XR environment for display by a display of the XR device. In some cases, the 2D rendering of the global mesh 812 may be performed in a manner substantially similar to how the XR device would render a 2D display of a local mesh generated by the XR device. In some cases, the target area may be visible through the objects that are set to transparent/some transparency level.

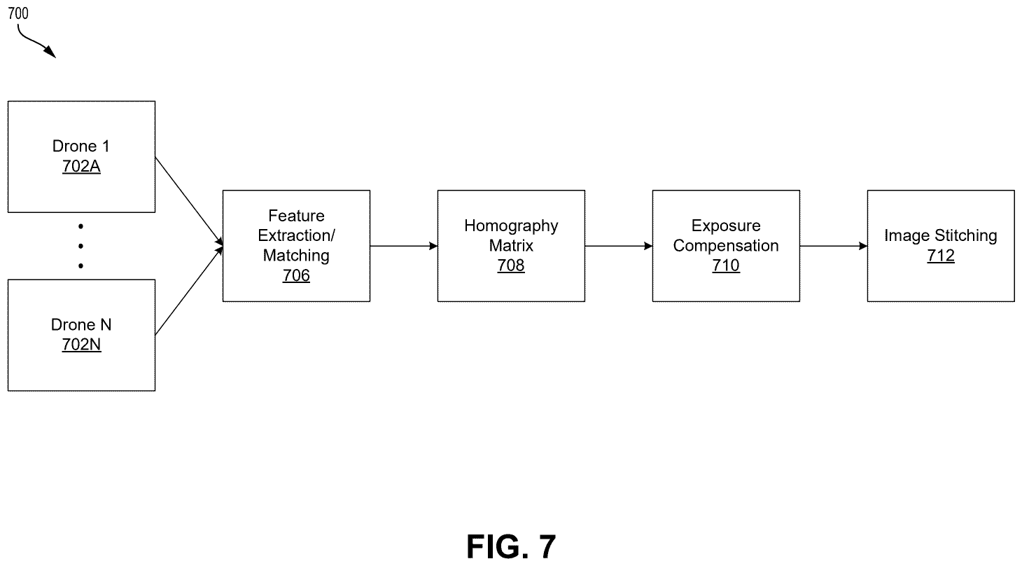

FIG. 9 is a flow diagram illustrating another technique for generating a 2D XR view using remote sensor using remote sensors 900, in accordance with aspects of the present disclosure. The XR device may be electronically coupled to one or more drones 902A, . . . 902N (collectively drones 902). The drones 902 may obtain images of the target area and/or portions of an area between the target area and XR device (e.g., a portion of the environment within view of the drones 902), along with depth information corresponding to the images. The drones 902 may send the images of the target area, depth information (e.g., the depth information is optionally sent), pose information for the drones 902, and camera intrinsics matrix to the XR device. The information from the drones 902 may be used to train 904 a neural radiance field (NeRF) model. In some cases, the NeRF model may be ML model, such as a fully-connected deep network, that is trained to generate a volumetric representation of the portion of the environment as a vector valued function. The NeRF model may be trained based on the images of the target area and the pose information from the drones 902. The camera intrinsics matrix may provide viewpoint information for projecting query 3D points for projecting the 3D points to a frame. For example, for the images, camera rays may be marched through the scene in an image to generate a set of 3D points with a given radiance direction (e.g., into the position of the camera). For these points, a volume density and view-dependent emitted radiance for that spatial location may be predicted. The volume density and view-dependent emitted radiance may be used to generate an image using classical volume rendering across multiple points and a loss may be determined between the predicated image and the original image to further train the NeRF model.

After training, the NeRF model may be queried to render a novel view 906 (e.g., a view from the point of view of the XR device) using an XR device pose 908 and a camera intrinsic matrix 910 of an XR device camera. For example, the NeRF model may be queried using a set of 5D coordinates (e.g., spatial location (x, y, z) and viewing direction (θ, φ) based on the XR device pose 908) corresponding to pixels to be rendered for display by the XR device. The camera intrinsic matrix 910 may be used to project queried coordinates (e.g., based on the pose of the XR device/XR device camera) for rendering a view. In some cases, the XR device may render an entire view for display using the NeRF model. In other cases, the XR device may render those pixels which are obstructed by an object using the NeRF model. In some cases, 3D gaussian splatting may also be used in a manner similar to NeRF model. In some cases, the NeRF model may be trained 904, for example, by a device separate from the XR device and drones 902, such as a computing node. In such cases, the XR device may query the computing node to render the novel view 906 (e.g., based on the XR device pose 908 and a camera intrinsic matrix 910 of an XR device camera), or the computing node may transmit the trained NeRF model to the XR device for rendering.

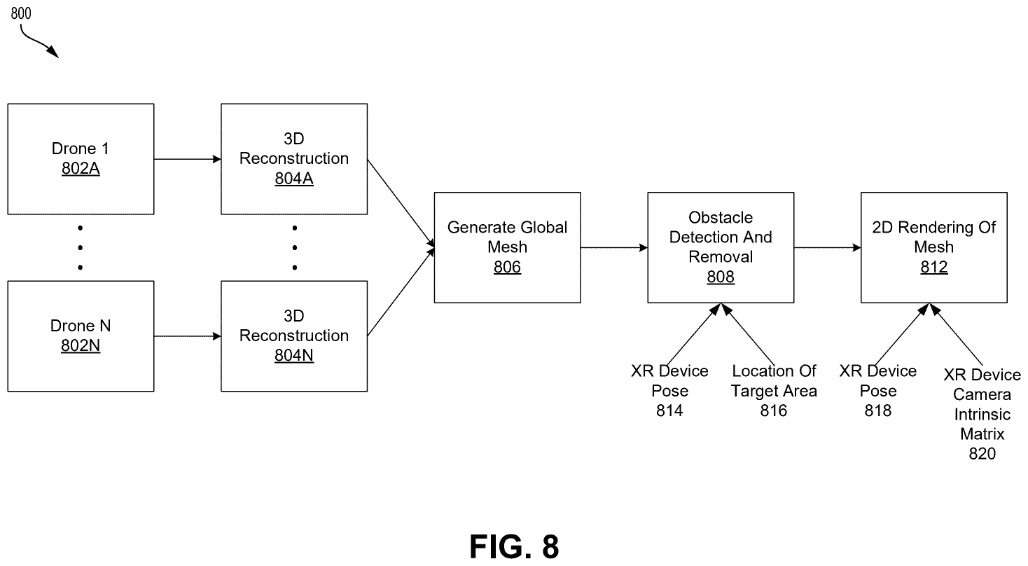

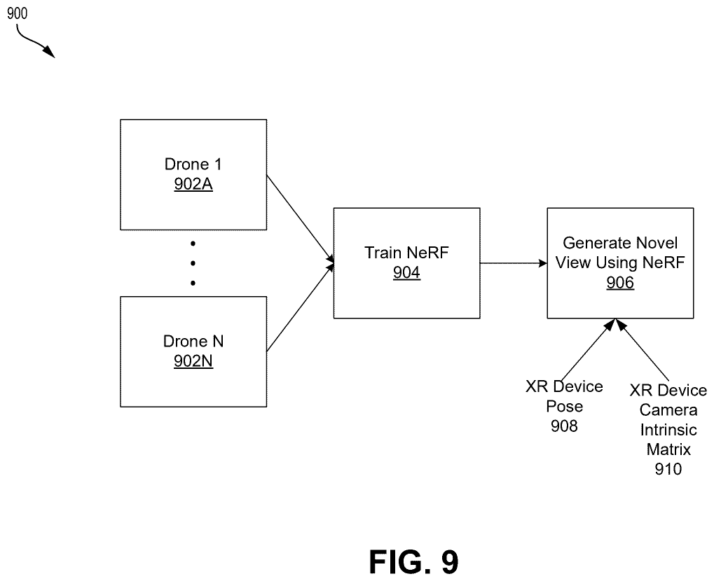

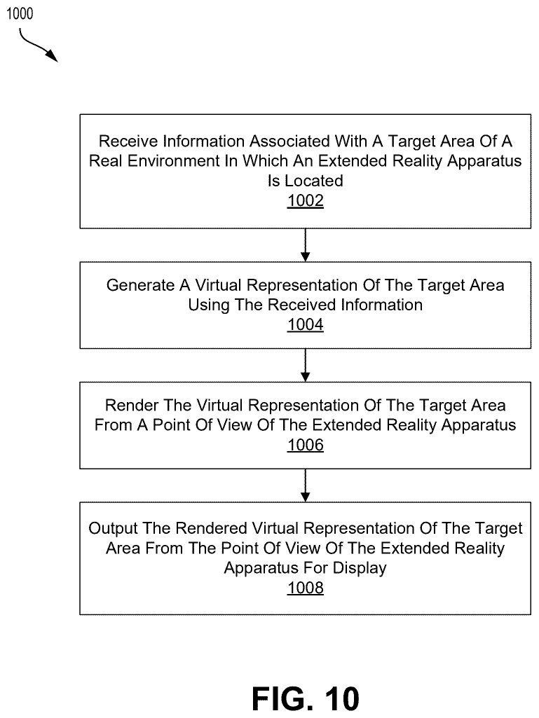

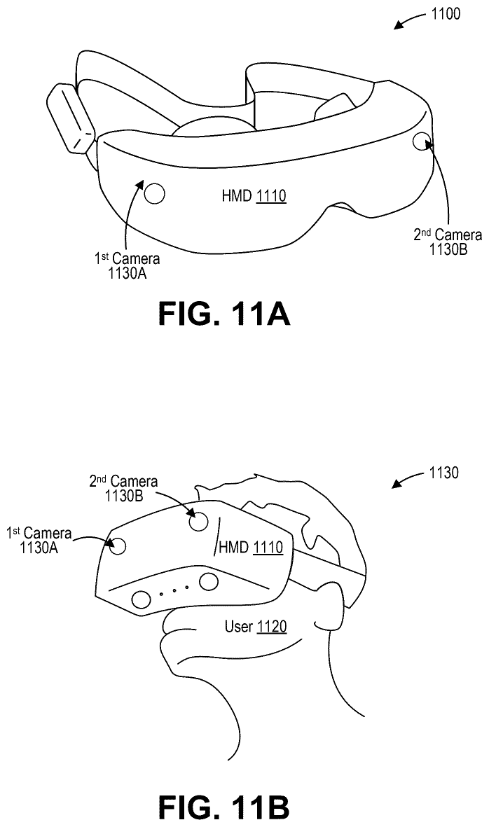

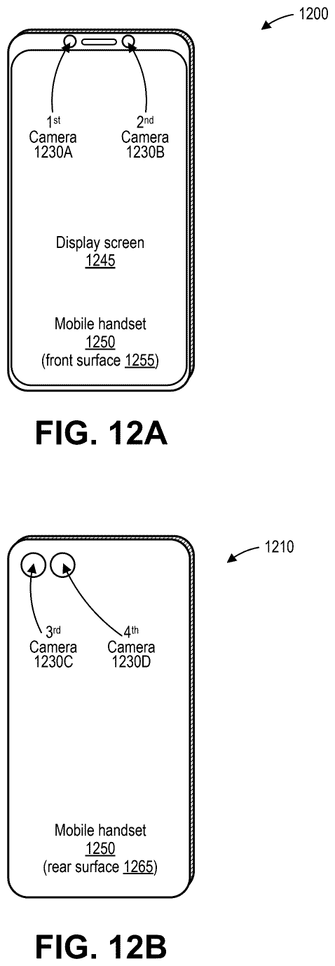

FIG. 10 is a flow diagram illustrating a process 1000 for rendering images for display by an extended reality device, in accordance with aspects of the present disclosure. The process 1000 may be performed by a computing device (or apparatus) or a component (e.g., a chipset, codec, etc.) of the computing device, such as host processor 152 of FIG. 1, compute components 210 of FIG. 2, XR device 506 of FIG. 5, HMD 604 of FIG. 6, and/or processor 1310 of FIG. 13. The computing device may be a mobile device (e.g., a mobile phone, XR device 506 of FIG. 5, HMD 604 of FIG. 6, mobile device 1250 of FIGS. 12A and 12B, computing system 1300 of FIG. 13, etc.), a network-connected wearable such as a watch, an extended reality (XR) device such as a virtual reality (VR) device or augmented reality (AR) device (e.g., XR device 506 of FIG. 5, HMD 604 of FIG. 6, HMD 1110 of FIGS. 11A and 11B, mobile device 1250 of FIGS. 12A and 12B, computing system 1300 of FIG. 13, etc.), a companion device, vehicle or component or system of a vehicle, or other type of computing device. The operations of the process 1000 may be implemented as software components that are executed and run on one or more processors (e.g., host processor 152 of FIG. 1, compute components 210 of FIG. 2, and/or processor 1310 of FIG. 13).

At block 1002, the computing device (or component thereof) may receive, from a remote sensor (e.g., drone 602 of FIG. 6, drone 702 of FIG. 7, drone 802 of FIG. 8, drone 902 of FIG. 9, etc.), information associated with a target area (e.g., target of interest 504 of FIG. 5) of a real environment in which the computing device (e.g., extended reality apparatus) is located. In some cases, the remote sensor is included in a drone. As another example, the remote sensor may be a static sensor. In some examples, the remote sensor comprises a plurality of sensors distributed in the real environment. In some cases, the information associated with the target area of the real environment comprises images of the target area. In some cases, the computing device (or component thereof) may transform (e.g., based on a homography matrix 708 of FIG. 7) the images of the target area based on a first pose of the remote sensor and a second pose of the extended reality apparatus; and generate the virtual representation of the target area based on the transformed images of the target area. In some examples, the computing device (or component thereof) may determine the first pose of the remote sensor based on features of the images of the target area. For example, where the set of images are provided to the XR device without pose information, the XR device may perform feature extraction/matching on images of the set of images to determine the pose of the remote sensor. In some cases, the computing device (or component thereof) may receive the first pose of the remote sensor from the remote sensor. In some cases, the information associated with the target area comprises a 3-dimensional (3D) reconstruction of the target area (e.g., global mesh 806 of FIG. 8, trained NeRF 904 of FIG. 9) based on an image captured by a camera of the remote sensor. In some examples, information associated with the target area of the real environment comprises images of the target area. In some cases, the computing device (or components thereof) may, train a neural radiance field (NeRF) model of the target area using images of the target area; and render the virtual representation of the target area by querying the NeRF model of the target area based on a pose of the extended reality apparatus. In some cases, the target area of the real environment is obstructed from at least one sensor of the extended reality apparatus.

At block 1004, the computing device (or component thereof) may generate a virtual representation of the target area (e.g., view 508 of FIG. 5, homography matrix 708 of FIG. 7, reconstructions 804 of FIG. 8, global mesh 806 of FIG. 8, trained 904 NeRF model of FIG. 9, etc.) using the received information. In some cases, the computing device (or component thereof) may to generate the virtual representation of the target area by generating a first local mesh (e.g., reconstructions 804 of FIG. 8) based on an image captured by a camera of the extended reality apparatus; and generate a global mesh (e.g., global mesh 806 of FIG. 8) based on the first local mesh and the information associated with the target area.

At block 1006, the computing device (or component thereof) may render the virtual representation of the target area (e.g., stitched 712 view of FIG. 7, 2D rendering of the global mesh 812 of FIG. 8, render a novel view 906 of FIG. 9, etc.) from a point of view of the extended reality apparatus.

At block 1008, the computing device (or component thereof) may output the rendered virtual representation of the target area from the point of view of the extended reality apparatus for display.

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 1000 and/or other processes described herein may include a processor, microprocessor, micro-computer, or other component of a device that is configured to carry out the steps of the process 1000 and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 1000 and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1000 is illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 1000 and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 11A is a perspective diagram 1100 illustrating a head-mounted display (HMD) 1110, in accordance with some examples. The HMD 1110 may be, for example, an augmented reality (AR) headset, a virtual reality (VR) headset, a mixed reality (MR) headset, an extended reality (XR) headset, or some combination thereof. The HMD 1110 may be an example of an XR device 200, a SLAM system, or a combination thereof. The HMD 1110 includes a first camera 1130A and a second camera 1130B along a front portion of the HMD 1110. In some examples, the HMD 1110 may only have a single camera. In some examples, the HMD 1110 may include one or more additional cameras in addition to the first camera 1130A and the second camera 1130B. In some examples, the HMD 1110 may include one or more additional sensors in addition to the first camera 1130A and the second camera 1130B.

FIG. 11B is a perspective diagram 1130 illustrating the head-mounted display (HMD) 1110 of FIG. 11A being worn by a user 1120, in accordance with some examples. The user 1120 wears the HMD 1110 on the user 1120's head over the user 1120's eyes. The HMD 1110 can capture images with the first camera 1130A and the second camera 1130B. In some examples, the HMD 1110 displays one or more display images toward the user 1120's eyes that are based on the images captured by the first camera 1130A and the second camera 1130B. The display images may provide a stereoscopic view of the environment, in some cases with information overlaid and/or with other modifications. For example, the HMD 1110 can display a first display image to the user 1120's right eye, the first display image based on an image captured by the first camera 1130A. The HMD 1110 can display a second display image to the user 1120's left eye, the second display image based on an image captured by the second camera 1130B. For instance, the HMD 1110 may provide overlaid information in the display images overlaid over the images captured by the first camera 1130A and the second camera 1130B.

The HMD 1110 may include no wheels, propellers or other conveyance of its own. Instead, the HMD 1110 relies on the movements of the user 1120 to move the HMD 1110 about the environment. In some cases, for instance where the HMD 1110 is a VR headset, the environment may be entirely or partially virtual. If the environment is at least partially virtual, then movement through the virtual environment may be virtual as well. For instance, movement through the virtual environment can be controlled by an input device 208. The movement actuator may include any such input device 208. Movement through the virtual environment may not require wheels, propellers, legs, or any other form of conveyance. Even if an environment is virtual, SLAM techniques may still be valuable, as the virtual environment can be unmapped and/or may have been generated by a device other than the HMD 1110, such as a remote server or console associated with a video game or video game platform.

FIG. 12A is a perspective diagram 1200 illustrating a front surface 1255 of a mobile device 1250 that performs features described here, including, for example, feature tracking and/or visual simultaneous localization and mapping (VSLAM) using one or more front-facing cameras 1230A-B, in accordance with some examples. The mobile device 1250 may be, for example, a cellular telephone, a satellite phone, a portable gaming console, a music player, a health tracking device, a wearable device, a wireless communication device, a laptop, a mobile device, any other type of computing device or computing system (e.g., computing system 1300 of FIG. 13) discussed herein, or a combination thereof. The front surface 1255 of the mobile device 1250 includes a display screen 1245. The front surface 1255 of the mobile device 1250 includes a first camera 1230A and a second camera 1230B. The first camera 1230A and the second camera 1230B are illustrated in a bezel around the display screen 1245 on the front surface 1255 of the mobile device 1250. In some examples, the first camera 1230A and the second camera 1230B can be positioned in a notch or cutout that is cut out from the display screen 1245 on the front surface 1255 of the mobile device 1250. In some examples, the first camera 1230A and the second camera 1230B can be under-display cameras that are positioned between the display screen 1245 and the rest of the mobile device 1250, so that light passes through a portion of the display screen 1245 before reaching the first camera 1230A and the second camera 1230B. The first camera 1230A and the second camera 1230B of the perspective diagram 1200 are front-facing cameras. The first camera 1230A and the second camera 1230B face a direction perpendicular to a planar surface of the front surface 1255 of the mobile device 1250. In some examples, the front surface 1255 of the mobile device 1250 may only have a single camera. In some examples, the mobile device 1250 may include one or more additional cameras in addition to the first camera 1230A and the second camera 1230B. In some examples, the mobile device 1250 may include one or more additional sensors in addition to the first camera 1230A and the second camera 1230B.

FIG. 12B is a perspective diagram 1210 illustrating a rear surface 1265 of a mobile device 1250. The mobile device 1250 includes a third camera 1230C and a fourth camera 1230D on the rear surface 1265 of the mobile device 1250. The third camera 1230C and the fourth camera 1230D of the perspective diagram 1210 are rear-facing. The third camera 1230C and the fourth camera 1230D face a direction perpendicular to a planar surface of the rear surface 1265 of the mobile device 1250. While the rear surface 1265 of the mobile device 1250 does not have a display screen 1245 as illustrated in the perspective diagram 1210, in some examples, the rear surface 1265 of the mobile device 1250 may have a second display screen. If the rear surface 1265 of the mobile device 1250 has a display screen 1245, any positioning of the third camera 1230C and the fourth camera 1230D relative to the display screen 1245 may be used as discussed with respect to the first camera 1230A and the second camera 1230B at the front surface 1255 of the mobile device 1250. In some examples, the rear surface 1265 of the mobile device 1250 may only have a single camera. In some examples, the mobile device 1250 may include one or more additional cameras in addition to the first camera 1230A, the second camera 1230B, the third camera 1230C, and the fourth camera 1230D. In some examples, the mobile device 1250 may include one or more additional sensors in addition to the first camera 1230A, the second camera 1230B, the third camera 1230C, and the fourth camera 1230D.

Like the HMD 1110, the mobile device 1250 includes no wheels, propellers, or other conveyance of its own. Instead, the mobile device 1250 relies on the movements of a user holding or wearing the mobile device 1250 to move the mobile device 1250 about the environment. In some cases, for instance where the mobile device 1250 is used for AR, VR, MR, or XR, the environment may be entirely or partially virtual. In some cases, the mobile device 1250 may be slotted into a head-mounted device (HMD) (e.g., into a cradle of the HMD) so that the mobile device 1250 functions as a display of the HMD, with the display screen 1245 of the mobile device 1250 functioning as the display of the HMD. If the environment is at least partially virtual, then movement through the virtual environment may be virtual as well. For instance, movement through the virtual environment can be controlled by one or more joysticks, buttons, video game controllers, mice, keyboards, trackpads, and/or other input devices that are coupled in a wired or wireless fashion to the mobile device 1250.

FIG. 13 is a diagram illustrating an example of a system for implementing certain aspects of the present technology. In particular, FIG. 13 illustrates an example of computing system 1300, which can be for example any computing device making up internal computing system, a remote computing system, a camera, or any component thereof in which the components of the system are in communication with each other using connection 1305. Connection 1305 can be a physical connection using a bus, or a direct connection into processor 1310, such as in a chipset architecture. Connection 1305 can also be a virtual connection, networked connection, or logical connection.

In some examples, computing system 1300 is a distributed system in which the functions described in this disclosure can be distributed within a datacenter, multiple data centers, a peer network, etc. In some examples, one or more of the described system components represents many such components each performing some or all of the functions for which the component is described. In some cases, the components can be physical or virtual devices.

Example system 1300 includes at least one processing unit (CPU or processor) 1310 and connection 1305 that couples various system components including system memory 1315, such as read-only memory (ROM) 1320 and random access memory (RAM) 1325 to processor 1310. Computing system 1300 can include a cache 1312 of high-speed memory connected directly with, in close proximity to, or integrated as part of processor 1310.

Processor 1310 can include any general purpose processor and a hardware service or software service, such as services 1332, 1334, and 1336 stored in storage device 1330, configured to control processor 1310 as well as a special-purpose processor where software instructions are incorporated into the actual processor design. Processor 1310 may be a completely self-contained computing system, containing multiple cores or processors, a bus, memory controller, cache, etc. A multi-core processor may be symmetric or asymmetric.

To enable user interaction, computing system 1300 includes an input device 1345, which can represent any number of input mechanisms, such as a microphone for speech, a touch-sensitive screen for gesture or graphical input, keyboard, mouse, motion input, speech, camera, accelerometers, gyroscopes, etc. Computing system 1300 can also include output device 1335, which can be one or more of a number of output mechanisms. In some instances, multimodal systems can enable a user to provide multiple types of input/output to communicate with computing system 1300. Computing system 1300 can include communications interface 1340, which can generally govern and manage the user input and system output. The communication interface may perform or facilitate receipt and/or transmission of wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1340 may also include one or more Global Navigation Satellite System (GNSS) receivers or transceivers that are used to determine a location of the computing system 1300 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1330 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 1330 can include software services, servers, services, etc., that when the code that defines such software is executed by the processor 1310, it causes the system to perform a function. In some examples, a hardware service that performs a particular function can include the software component stored in a computer-readable medium in connection with the necessary hardware components, such as processor 1310, connection 1305, output device 1335, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some examples, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the examples provided herein. However, it will be understood by one of ordinary skill in the art that the examples may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the examples in unnecessary detail. In other instances, well-known circuits, processes, algorithms, structures, and techniques may be shown without unnecessary detail in order to avoid obscuring the examples.

Individual examples may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples thereof, but those skilled in the art will recognize that the application is not limited thereto. Thus, while illustrative examples of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, examples can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

Claim language or other language reciting “at least one processor configured to,” “at least one processor being configured to,” “a processor configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the present disclosure include:
Aspect 1. An extended reality apparatus, comprising: a memory; and at least one processor coupled to the memory, wherein the at least one processor is configured to: receive, from a remote sensor, information associated with a target area of a real environment in which the extended reality apparatus is located; generate a virtual representation of the target area using the received information; render the virtual representation of the target area from a point of view of the extended reality apparatus; and output the rendered virtual representation of the target area from the point of view of the extended reality apparatus for display.
Aspect 2. The extended reality apparatus of Aspect 1, wherein the remote sensor is included in a drone.
Aspect 3. The extended reality apparatus of any of Aspects 1-2, wherein the information associated with the target area of the real environment comprises images of the target area, and wherein the at least one processor is configured to: transform the images of the target area based on a first pose of the remote sensor and a second pose of the extended reality apparatus; and generate the virtual representation of the target area based on the transformed images of the target area.
Aspect 4. The extended reality apparatus of Aspect 3, wherein the at least one processor is configured to determine the first pose of the remote sensor based on features of the images of the target area.
Aspect 5. The extended reality apparatus of any of Aspects 3-4, wherein the at least one processor is configured to receive the first pose of the remote sensor from the remote sensor.
Aspect 6. The extended reality apparatus of any of Aspects 1-5, wherein, to generate the virtual representation of the target area, the at least one processor is configured to: generate a first local mesh based on an image captured by a camera of the extended reality apparatus; and generate a global mesh based on the first local mesh and the information associated with the target area.
Aspect 7. The extended reality apparatus of Aspect 6, wherein the information associated with the target area comprises a 3-dimensional (3D) reconstruction of the target area based on an image captured by a camera of the remote sensor.
Aspect 8. The extended reality apparatus of Aspect 7, wherein the 3D reconstruction of the target area comprises a second local mesh.
Aspect 9. The extended reality apparatus of any of Aspects 1-8, wherein the information associated with the target area of the real environment comprises images of the target area, and wherein the at least one processor is configured to: train a neural radiance field (NeRF) model of the target area using images of the target area; and render the virtual representation of the target area by querying the NeRF model of the target area based on a pose of the extended reality apparatus.
Aspect 10. The extended reality apparatus of any of Aspects 1-9, wherein the remote sensor comprises a plurality of sensors distributed in the real environment.
Aspect 11. The extended reality apparatus of any of Aspects 1-10, wherein the target area of the real environment is obstructed from at least one sensor of the extended reality apparatus.
Aspect 12. A method for generating a view, comprising: receiving, from a remote sensor, information associated with a target area of a real environment in which an extended reality apparatus is located; generating a virtual representation of the target area using the received information; rendering the virtual representation of the target area from a point of view of the extended reality apparatus; and outputting the rendered virtual representation of the target area from the point of view of the extended reality apparatus for display.
Aspect 13. The method of Aspect 12, wherein the remote sensor is included in a drone.
Aspect 14. The method of any of Aspects 12-13, wherein the information associated with the target area of the real environment comprises images of the target area, and further comprising: transforming the images of the target area based on a first pose of the remote sensor and a second pose of the extended reality apparatus; and generating the virtual representation of the target area based on the transformed images of the target area.
Aspect 15. The method of Aspect 14, further comprising determining the first pose of the remote sensor based on features of the images of the target area.
Aspect 16. The method of any of Aspects 14-15, further comprising receiving the first pose of the remote sensor from the remote sensor.
Aspect 17. The method of any of Aspects 12-16, wherein generating the virtual representation of the target area comprises: generating a first local mesh based on an image captured by a camera of the extended reality apparatus; and generating a global mesh based on the first local mesh and the information associated with the target area.
Aspect 18. The method of Aspect 17, wherein the information associated with the target area comprises a 3-dimensional (3D) reconstruction of the target area based on an image captured by a camera of the remote sensor.
Aspect 19. The method of Aspect 18, wherein the 3D reconstruction of the target area comprises a second local mesh.
Aspect 20. The method of any of Aspects 12-19, wherein the information associated with the target area of the real environment comprises images of the target area, and further comprising: training a neural radiance field (NeRF) model of the target area using images of the target area; and rendering the virtual representation of the target area by querying the NeRF model of the target area based on a pose of the extended reality apparatus.
Aspect 21. The method of any of Aspects 12-20, wherein the remote sensor comprises a plurality of sensors distributed in the real environment.
Aspect 22. A non-transitory computer-readable medium having stored thereon instructions that, when executed by at least one processor, cause the at least one processor to perform operations according to any of Aspects 12-21.
Aspect 23. An apparatus for generating a view, comprising one or more means for performing operations according to any of Aspects 12-21.

What is claimed is:

1. An extended reality apparatus, comprising:
a memory; and
at least one processor coupled to the memory, wherein the at least one processor is configured to:
receive, from a remote sensor, information associated with a target area of a real environment in which the extended reality apparatus is located;
generate a virtual representation of the target area using the received information;
render the virtual representation of the target area from a point of view of the extended reality apparatus; and
output the rendered virtual representation of the target area from the point of view of the extended reality apparatus for display.

2. The extended reality apparatus of claim 1, wherein the remote sensor is included in a drone.

3. The extended reality apparatus of claim 1, wherein the information associated with the target area of the real environment comprises images of the target area, and wherein the at least one processor is configured to:
transform the images of the target area based on a first pose of the remote sensor and a second pose of the extended reality apparatus; and
generate the virtual representation of the target area based on the transformed images of the target area.

4. The extended reality apparatus of claim 3, wherein the at least one processor is configured to determine the first pose of the remote sensor based on features of the images of the target area.

5. The extended reality apparatus of claim 3, wherein the at least one processor is configured to receive the first pose of the remote sensor from the remote sensor.

6. The extended reality apparatus of claim 1, wherein, to generate the virtual representation of the target area, the at least one processor is configured to:
generate a first local mesh based on an image captured by a camera of the extended reality apparatus; and
generate a global mesh based on the first local mesh and the information associated with the target area.

7. The extended reality apparatus of claim 6, wherein the information associated with the target area comprises a 3-dimensional (3D) reconstruction of the target area based on an image captured by a camera of the remote sensor.

8. The extended reality apparatus of claim 7, wherein the 3D reconstruction of the target area comprises a second local mesh.

9. The extended reality apparatus of claim 1, wherein the information associated with the target area of the real environment comprises images of the target area, and wherein the at least one processor is configured to:
train a neural radiance field (NeRF) model of the target area using images of the target area; and
render the virtual representation of the target area by querying the NeRF model of the target area based on a pose of the extended reality apparatus.

10. The extended reality apparatus of claim 1, wherein the remote sensor comprises a plurality of sensors distributed in the real environment.

11. The extended reality apparatus of claim 1, wherein the target area of the real environment is obstructed from at least one sensor of the extended reality apparatus.

12. A method for generating a view, comprising:
receiving, from a remote sensor, information associated with a target area of a real environment in which an extended reality apparatus is located;
generating a virtual representation of the target area using the received information;
rendering the virtual representation of the target area from a point of view of the extended reality apparatus; and
outputting the rendered virtual representation of the target area from the point of view of the extended reality apparatus for display.

13. The method of claim 12, wherein the remote sensor is included in a drone.

14. The method of claim 12, wherein the information associated with the target area of the real environment comprises images of the target area, and further comprising:
transforming the images of the target area based on a first pose of the remote sensor and a second pose of the extended reality apparatus; and
generating the virtual representation of the target area based on the transformed images of the target area.

15. The method of claim 14, further comprising determining the first pose of the remote sensor based on features of the images of the target area.

16. The method of claim 14, further comprising receiving the first pose of the remote sensor from the remote sensor.

17. The method of claim 12, wherein generating the virtual representation of the target area comprises:
generating a first local mesh based on an image captured by a camera of the extended reality apparatus; and
generating a global mesh based on the first local mesh and the information associated with the target area.

18. The method of claim 17, wherein the information associated with the target area comprises a 3-dimensional (3D) reconstruction of the target area based on an image captured by a camera of the remote sensor.

19. The method of claim 18, wherein the 3D reconstruction of the target area comprises a second local mesh.

20. The method of claim 13, wherein the information associated with the target area of the real environment comprises images of the target area, and further comprising:
training a neural radiance field (NeRF) model of the target area using images of the target area; and
rendering the virtual representation of the target area by querying the NeRF model of the target area based on a pose of the extended reality apparatus.
